(19) United States
(12) Patent Application Publication
(10) Pub. No.: US 2004/0241388 A1
(43) Pub. Date: Dec. 2, 2004

(54) Rollbar padding

(76) Inventor: James Michael Ray JR., Mooresville, NC (US)

Correspondence Address: Adams Evans P.A., 2180 Two Wachovia Center, Charlotte, NC, 28282, US

(21) Appl. No.: 10/447,430

(22) Filed: May 29, 2003

(51) Int. Cl. B32B 3/04

(52) U.S. Cl. 428/122

(57) ABSTRACT

A padding for a rollbar tube is an elongated member of resilient material having a substantially uniform cross-section. The cross-section is defined by an upper portion and a lower portion having a common maximum width greater than the width of the tube. The lower portion includes a concave arcuate recess for receiving the rollbar tube, and the upper portion is of substantially constant thickness across the entire maximum width of the padding

### BACKGROUND OF THE INVENTION

This invention relates generally to safety padding and more particularly to padding for use with a rollbar. Rollbars or rollcages are commonly used to protect occupants in racing cars and other vehicles from injuries in case of a collision or accident. The rollbar or rollcage is typically constructed of one or more high strength, rigid tubular members disposed in a three-dimensional arrangement so as to define a protected volume inside the vehicle. The rollbar or rollcage is stronger than the body of the vehicle so that in case of an impact or rollover, crushing or deformation of the body is limited, thus protecting the vehicle's occupants.

Although a rollbar or rollcage protects the vehicle from crushing, the tubes that form the rollbar or rollcage can injure an occupant in case the occupant strikes the tubes during a collision. Therefore, it is common practice to apply some kind of resilient padding to the tubes. This padding generally takes the form of a cylindrical member having a constant radial thickness. While this provides protection, the cylindrical shape presents a relatively narrow impact area which tends to concentrate impact forces. Furthermore, the round shape results in reduced protection should the occupant's impact be offset from the center of the tube. Also because of the padding shape, if it is desired to increase the padding thickness, it must be increased all the way around the tube, which wastes material.

Accordingly, there is a need for a roll bar padding which provides improved impact characteristics and efficient use of material.

### BRIEF SUMMARY OF THE INVENTION

Therefore, it is an object of the invention to provide a roll bar padding which provides increased protection for a vehicle occupant.

It is another object of the invention to provide a roll bar padding which presents a selected thickness of padding in a impact direction while minimizing the amount of material used.

These and other objects of the present invention are achieved in the preferred embodiments disclosed below by providing The above-mentioned need is met by the present invention, which according to one embodiment provides a padding comprising an elongated member of resilient material having a substantially uniform cross-section bounded by a substantially planar impact face, a mounting face spaced-apart from said impact face, and a pair of spaced-apart side faces. The mounting face includes a concave arcuate recess for receiving an elongated tube.

According to another embodiment of the present invention, the resilient material comprises polyurethane foam.

According to another embodiment of the present invention, a padding for a rollbar tube has a first width. The padding comprises an elongated member of resilient material having a substantially uniform cross-section. The cross-section is defined by an upper portion and a lower portion having a common maximum width which is greater than the first width, wherein the lower portion includes a concave arcuate recess for receiving the rollbar tube, and said upper portion is of substantially constant thickness across said entire maximum width.

According to another embodiment of the present invention, the thickness of the upper portion of the padding is about 30 mm.

According to another embodiment of the present invention, the resilient material comprises polyurethane foam.

According to another embodiment of the present invention, a rollbar pad comprises homogeneous elongated resilient material of substantially uniform cross-section bounded by spaced-apart first and second faces joined by spaced-apart first and second sides. The first face is arcuate with a first radius of curvature. The second face comprises a generally semi-cylindrical concave surface flanked by a pair of generally planar surfaces, where the concave surface has a second radius of curvature which is substantially less than the first radius of curvature. The first side comprises a generally planar portion which joins the first planar surface and a convex arcuate second portion which joins the first face. A second side comprises a generally planar portion which joins the second planar surface and a convex arcuate second portion which joins the first face.

According to another embodiment of the present invention, the first radius of curvature of the padding is at least about 7.9 times greater than the second radius of curvature.

According to another embodiment of the present invention, a rollbar assembly comprises an elongated tube having a generally circular cross-section and inner and outer surfaces. A padding is attached to the tube, and comprises a resilient material formed into an elongated member with a substantially uniform cross section having a generally planar first face spaced apart from a concave generally semicircular second face, a first side extending between the first and second faces, and a second side extending between the first and second faces. The second face is disposed against the outer surface of the tube.

According to another embodiment of the present invention, the impact face is oriented in a direction of impact.

The present invention and its advantages over the prior art will become apparent upon reading the following detailed description and the appended claims with reference to the accompanying drawings.

### BRIEF DESCRIPTION OF THE DRAWINGS

The subject matter that is regarded as the invention is particularly pointed out and distinctly claimed in the concluding part of the specification. The invention, however, may be best understood by reference to the following description taken in conjunction with the accompanying drawing figures in which:

FIG. 1 is a schematic perspective view of a section of padding constructed in accordance with the present invention;

FIG. 2 is a cross-sectional view of the padding of FIG. 1; and

FIG. 3 is a cross-sectional view of the padding of FIG. 1 in conjunction with a rollbar tube.

### DETAILED DESCRIPTION OF THE INVENTION

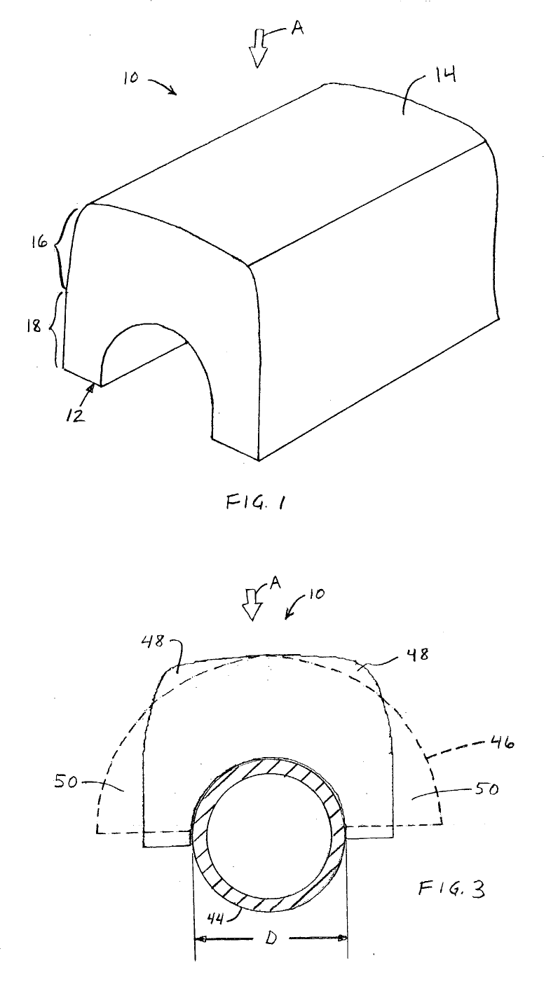

Referring to the drawings wherein identical reference numerals denote the same elements throughout the various views, FIG. 1 shows a section of padding 10 constructed in accordance with the present invention. It should be noted that the padding described by way of example herein is suitable not only for use with a rollbar or rollcage, but with any type of protective structure having similar construction. The padding 10 comprises an elongated member having a mounting face 12 which is shaped so as to be fitted over a rollbar tube (not shown) and a spaced-apart impact face 14 that is installed facing the direction of intended impact (denoted “A” in FIG. 1). The cross-section of the member is substantially uniform throughout its length. The overall cross-section may be generally divided into an upper portion 16 which is of a substantially uniform thickness and a lower portion 18 which includes a concave arcuate recess 20 for receiving a tube. The padding 10 comprises a resilient material which absorbs and cushions the force of an impact therewith. Any known type of resilient material may be used, for example open-cell polyurethane foam. If desired, the padding may include a smooth outer cover or skin (not shown).

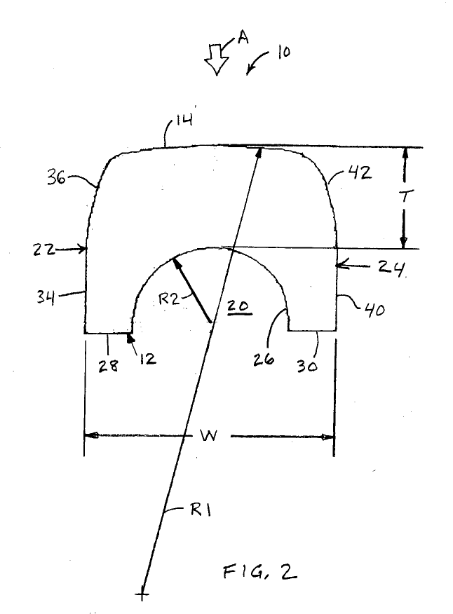

FIG. 2 illustrates the cross-section of the padding 10 in more detail. The cross-section is bounded by the impact face 14, the mounting face 12, a first side 22, and a second side 24. The impact face 14 has a first radius of curvature, denoted R1. As explained below, the first radius R1 is large enough that the variation in the height or A-direction within the overall width of the padding 10 is a small fraction of the total thickness of the padding 10 (for example a few millimeters). Accordingly, the impact face 14 may be considered substantially planar. The mounting face 12 comprises a concave arcuate surface 26. In the illustrated example the concave surface 26 is generally semi-cylindrical and defines a second radius of curvature denoted R2. This radius of curvature R2 is substantially less than the first radius of curvature R1, as explained in more detail below. It is noted that the first and second radii R1 and R2 do not share the same center, as illustrated in FIG. 2. Shapes other than semi-cylindrical could be used as well, depending upon the shape of the tubing member to be used. In the illustrated example, the concave surface 26 is flanked by first and second generally planar surfaces 28 and 30, although the shape of these surfaces is not of particular importance and may be varied.

The first side 22 connects the first planar surface 28 and the impact face 14. The first side 22 comprises a first portion 34 that is generally planar and joins the first planar surface 28. A second portion 36 is convex and arcuate and joins the impact face 14. A second side connects the second planar surface 30 and the impact face 14. The second side 24 is a mirror image of the first side 22 and comprises a first portion 40 that is generally planar and joins the first planar surface 28. A second portion 42 is convex and joins the impact face 14.

FIG. 3 illustrates the padding 10 installed on a tube 44 which is representative of a rollbar or rollcage structural member. The padding is cut to an appropriate length. The padding 10 is then placed over the tube 44 so that the tube 44 is received in the concave surface 26. The padding 10 is oriented so that the impact face 14 is perpendicular to an intended direction of impact “A”. The padding 10 may be cut to form mitered corners to conform to bends or corners in the tube 44. The padding 10 may then be secured to the tubing 44 in any known fashion, for example, with plastic tie straps (not shown).

FIG. 3 also illustrates the cross-section of a prior art padding 46, shown in dashed lines and superimposed over the cross-section of the padding 10 of the present invention. The padding 10 has some areas 48 that represent additional material relative to the cross-section of the prior art padding, and other areas 50 that represent material removed relative to the prior art padding 46, which is a simple cylindrical shape of constant radial thickness. As can been seen, the padding 10 of the present invention provides an equal or greater thickness in the impact direction for its entire width while using an equal or lesser amount of material. The padding 10 allows the overall amount of material used to be minimized while maintaining a selected thickness of material in the direction of impact. This lowers the cost of the padding and also its weight, which may be important in some applications. This design also presents a flatter surface to spread out any impacts, and provides a substantially uniform amount of padding even in an offset impact.

Referring again to FIG. 2, an exemplary embodiment of a padding 10 intended to be used with a tube having an outside diameter D of approximately 45 mm (1.8 in.) may have the following dimensions: a first radius R1 of approximately 177.8 mm (7.0 in.); a second radius R2 of approximately 22.5 mm (0.89 in.); a padding thickness T of approximately 30 mm (1.2 in.); and a total width W of approximately 72 mm (2.8 in.) This results in an R1/R2 ratio of approximately 7.9. All of these dimensions are merely illustrative and may of course be varied to suit a particular application. The minimum padding thickness T is selected based on the estimated severity of impact, or relevant safety codes or standards for driver protection. The thickness T is not generally increased beyond the minimum amount, as it may interfere with the occupant's freedom of movement inside the vehicle. For other diameters of tubes, the first radius R1 would be generally be maintained at the same dimension while varying the second radius R2. For example, the same padding for use with a tube having a diameter D of approximately 38 mm (1.5 in.) would have a first radius R1 of approximately 177.8 mm (7.0 in.) and a second radius of approximately 19 mm (0.75 in.) This would result in a R1/R2 ratio of approximately 9.4 while maintaining a thickness T of approximately 30 mm (1.2 in.)

While specific embodiments of the present invention have been described, it will be apparent to those skilled in the art that various modifications thereto can be made without departing from the spirit and scope of the invention as defined in the appended claims.

What is claimed is:

1. A padding for use with a rollbar comprising an elongated member of resilient material having a substantially uniform cross-section bounded by a substantially planar impact face, a mounting face spaced-apart from said impact face, and a pair of spaced-apart side faces, wherein said mounting face includes a concave arcuate recess for receiving an elongated tube.

2. The padding of claim 1 wherein said resilient material comprises polyurethane foam.

3 A padding for a rollbar tube of a first width, said padding comprising an elongated member of resilient material having a substantially uniform cross-section, said cross-section defined by an upper portion and a lower portion having a common maximum width which is greater than said first width, wherein said lower portion includes a concave arcuate recess for receiving said rollbar tube, and said upper portion is of substantially constant thickness across said entire maximum width.

4. The padding of claim 3 wherein the thickness of said upper portion is about 30 mm.

5. The padding of claim 3 wherein said resilient material comprises polyurethane foam.

6. A rollbar pad comprising resilient material of substantially uniform cross-section bounded by spaced-apart first and second faces joined by spaced-apart first and second sides,
said first face being arcuate with a first radius of curvature,
said second face comprising a generally semi-cylindrical concave surface flanked by a pair of generally planar surfaces, said concave surface having a second radius of curvature which is less than said first radius of curvature;
said first side comprising a generally planar portion which joins said first planar surface and a convex arcuate second portion which joins said first face; and
said second side comprising a generally planar portion which joins said second planar surface and a convex arcuate second portion which joins said first face.

7. The padding of claim 6 wherein said resilient material comprises polyurethane foam.

8. The padding of claim 6 wherein the thickness of said upper portion is about 30 mm.

9. The padding of claim 8 wherein said first radius of curvature is at least about 7.9 times greater than said second radius of curvature.

10. A rollbar assembly comprising:
an elongated tube having a generally circular cross-section and inner and outer surfaces; and
a padding attached to said tube, said padding comprising: a resilient material formed into an elongated member with a substantially uniform cross section having a generally planar first face spaced apart from a concave generally semicircular second face, a first side extending between said first and second faces, and a second side extending between said first and second faces, wherein said second face is disposed against the outer surface of said tube.

11. The rollbar assembly of claim 10 wherein and said impact face is oriented in a direction of impact.

12. The padding of claim 10 wherein said resilient material comprises polyurethane foam.
